(19) United States
(12) Patent Application Publication
(10) Pub. No.: US 2007/0203682 A1
(43) Pub. Date: Aug. 30, 2007

(54) External display simulator

(75) Inventors: Madhuri Gummalla, Gachibowli (IN); Abhishek K. Mishra, Gachibowli (IN)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/364,581

(22) Filed: Feb. 28, 2006

(51) Int. Cl. G06F 17/50

(52) U.S. Cl. 703/13; 703/21

(57) ABSTRACT

An external display simulator is configured to internally verify data to be transmitted from a computing device to an output device by implementing display driver functionality. The external display simulator intercepts data output from an application executing on the computing device. The external display simulator supports many different display resolutions and modes. The external display simulator determines an appropriate display mode and forwards the data to a corresponding output destination. The data may then be compared to an expected result to determine whether the data is verified.

### BACKGROUND

Verifying images generated by an application is performed manually by viewing the images transmitted from a computing device to an attached display. For example, a presentation application executing on a mobile device requires an attached projector to determine if the data will be properly displayed. In some cases, application development progresses before supporting hardware is created, so an external display or supporting driver may not be available to verify the display data. Attempting to verify the images for another display type may be very cumbersome. For example, a “Print Screen” tool may have to be used to capture the images that are displayed in order to verify the images for the other display type. Additionally, in some cases, specialized hardware and drivers may be required to display images on the other display type.

### SUMMARY

An external display simulator is configured to act as a secondary display on which an application can display images. The external display simulator intercepts the display data from an application and may bypass the attached display hardware. The external display simulator is extensible and may be configured to support many different display resolutions and modes. The extensibility of the display mode support feature allows for the customization of the display data to be verified for any conceivable display mode. Thus, a monitor that supports a particular resolution need not be available to test whether corresponding output display data is properly rendered on the monitor. The external display simulator determines an appropriate display mode and forwards the display data to a corresponding output destination. The display data may then be compared to an expected result to determine whether the display data is verified.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a functional diagram illustrating a computing device in which an external display simulator application may be implemented.

FIG. 2 is a conceptual diagram illustrating major functional blocks involved in a system for simulating an external display.

FIG. 3 is an operational flow diagram illustrating a process for simulating an external display.

### DETAILED DESCRIPTION

An external display simulator provides great flexibility when used as a development platform because a developer may not have access to a range of displays or display drivers that support all display modes for which display data is to be verified. The external display simulator provides increased functionality in an automatic testing framework because any hardware display mode configuration can be modeled. The extensibility of the display mode support feature allows the display data from an application to be customized for any conceivable display mode. Thus, a monitor that supports a particular resolution need not be available to test whether corresponding output display data would be properly rendered on the monitor.

Embodiments of the present disclosure now will be described more fully hereinafter with reference to the accompanying drawings, which form a part hereof, and which show, by way of illustration, specific exemplary embodiments for practicing the invention. This disclosure may, however, be embodied in many different forms and should not be construed as limited to the embodiments set forth herein; rather, these embodiments are provided so that this disclosure will be thorough and complete, and will fully convey the scope to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

Illustrative Operating Environment

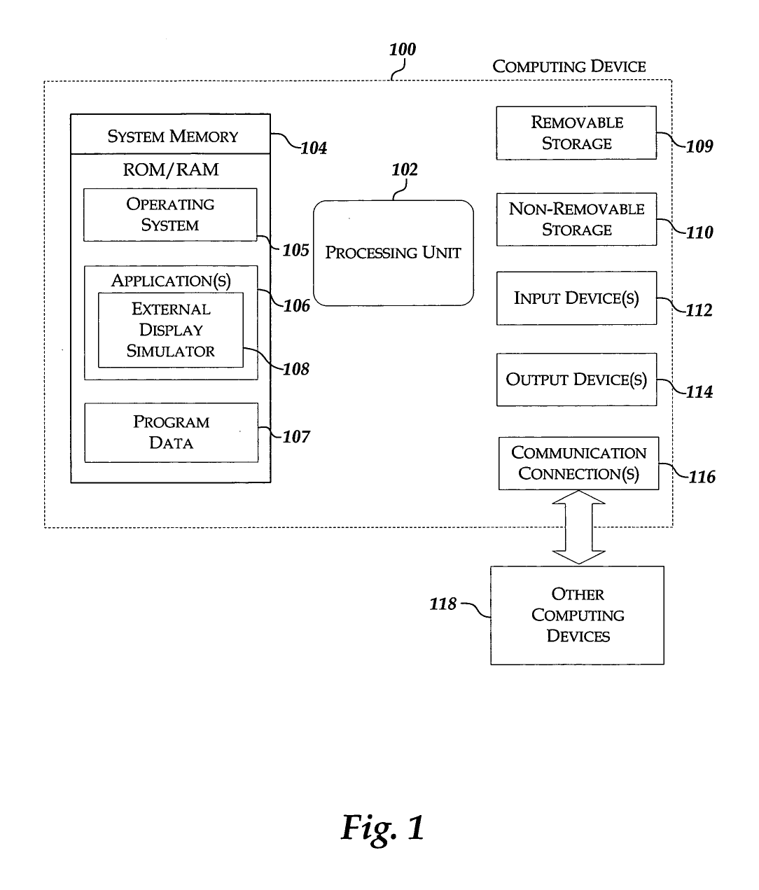

Referring to FIG. 1, an exemplary system for implementing an external display simulator application includes a computing device, such as computing device 100. Computing device 100 may be configured as a mobile computing device or as a conventional desktop computing device. In a basic configuration, computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes operating system 105, one or more applications 106, and may include program data 107. Depending on how computing device is configured, the operating system 105 may be an operating system such as the WINDOWS CE® or WINDOWS XP operating systems available from the Microsoft Corporation of Redmond, Wash. Alternatively, another operating system may be utilized. In one embodiment, applications 106 interact with external display simulator application 108 as discussed in further detail below.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as a keyboard, mouse, pen, voice input device, touch input device, etc. Output device(s) 114 such as a display, speakers, printer, etc. may also be included. The display may be an LCD, or any other type of display commonly used in a computing device. The display may be touch-sensitive, and would then also act as an input device.

Computing device 100 also contains communication connection(s) 116 that allow the device to communicate with other computing devices 118, such as over a wired network or a wireless network. Communication connection(s) 116 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The present disclosure is described in the general context of computer-executable instructions or components, such as software modules, being executed on a computing device. Generally, software modules include routines, programs, objects, components, data structures, and the like that perform particular tasks or implement particular abstract data types. Although described here in terms of computer-executable instructions or components, the present disclosure may equally be implemented using programmatic mechanisms other than software, such as firmware or special purpose logic circuits.

External Display Simulator

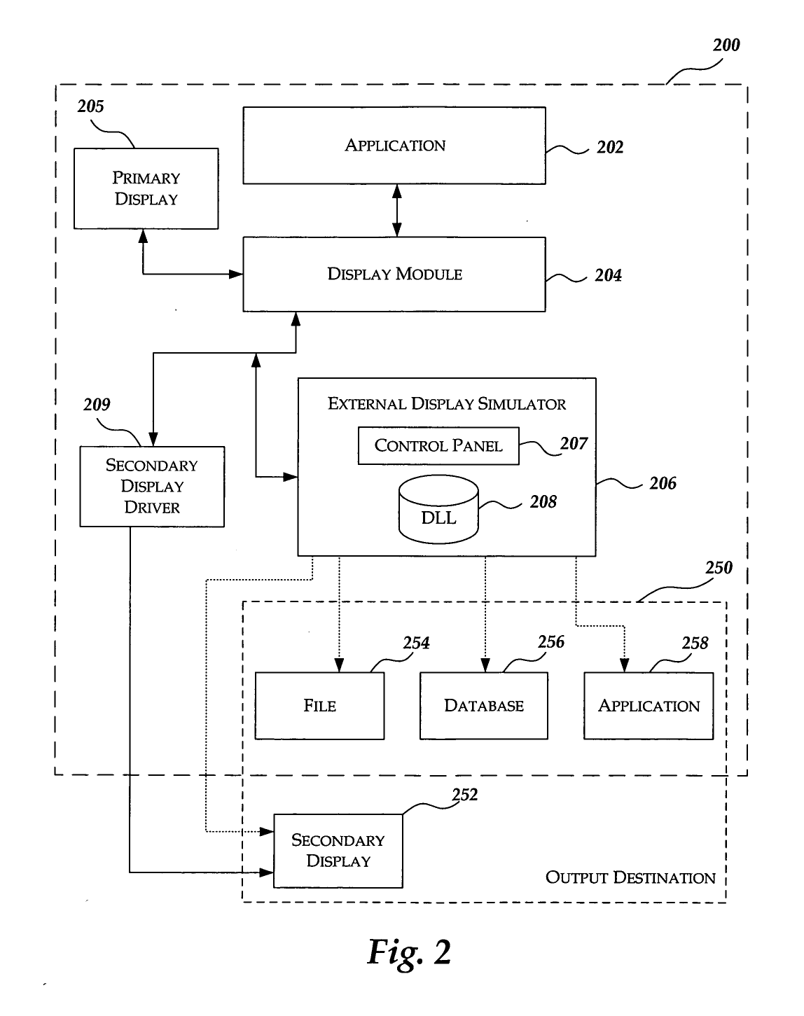

FIG. 2 is a conceptual diagram illustrating major functional blocks involved in a system for simulating an external display. The system includes computing device 200 that is configured to execute application 202. Computing device 200 may be a mobile computing device and/or a non-mobile computing device. Computing device 200 includes display module 204, primary display 205, external display simulator 206, and secondary display driver 209. Application 202, primary display 205, external display simulator 206, and secondary display driver 209 are coupled to display module 204. External display simulator 206 includes control panel 207 and dynamic link library 208. Control panel 207 is used to reprogram settings associated with external display simulator 206. Dynamic link library 208 includes data associated with simulating an external display. Secondary display driver 209 is coupled to secondary display 252. Output destination 250 is coupled to external display simulator 206. Output destination 250 may be external to computing device 200 such as secondary display 252. Output destination 250 may be included within computing device 200 such as file 254, database 256, application 258, primary display 205, or a memory device (not shown).

Application 202 may be any application that is configured to send display data to a display other than primary display 205. Primary display 205 may be a local display (e.g. an LCD) on computing device 200, or a local monitor coupled to computing device 200. Display module 204 is an interface between a user, application 202 and the operating system of computing device 200. For example, in a mobile communication device, display module 204 may be a graphics, windowing and events subsystem (GWES) module. Secondary display driver 209 is configured to provide functionality to secondary display 252. Secondary display 252 may be any output device that displays visual data, such as a projector.

In standard operation, application 202 generates and outputs display data for display on a secondary display. Application 202 queries display module 204 for an available active secondary display. Display module 204 provides secondary display information to application 202 when an active secondary display is available. Application 202 queries display module 204 for the display modes supported on the active secondary displays. Display module 204 queries secondary display driver 209 for the supported display modes. Secondary display driver 209 provides the supported display modes to display module 204. Example display modes may include resolution (e.g., width by height), bits-per-pixel, or video output mode (e.g. video graphics array, national television system committee standard, phase altering line standard, etc.). Display module 204 provides the supported display modes to application 202. Application 202 forwards the display data to be displayed to display module 204. The display data may correspond to visual information such as an image. Display module 204 receives the display data from application 202 and forwards the display data to secondary display driver 209. Secondary display driver 209 forwards the display data to secondary display 252 where the image may be visually perceived.

External display simulator 206 is configured to internally verify display data to be transmitted from computing device 200 to secondary display 252 by implementing display driver functionality. The display data may be verified within computing device 200 without transmitting the display data to secondary display 252. External display simulator 206 is configured to support many different display resolutions and modes. External display simulator 206 intercepts display data sent from display module 204 to secondary display driver 209, determines an appropriate display mode for the display data, and forwards the display data to output destination 250 for verification. For example, the display data received from application 202 may be uploaded to file 254. The display data may then be compared to an expected result by executing a comparison algorithm to determine whether the display data is verified.

In one embodiment, a visual difference algorithm (visual-diff) is used to determine whether the display data is verified. Visual-diff uses color-coding to compare display data stored in two different buffers. For example, the display data from the application may be an image. The image is compared to a baseline image that is formatted in accordance with the display mode selected by the application. The display data is verified when the images match. In other words, the image output from the application will render properly on a display configured to support the corresponding display mode. The baseline images may be stored locally in computing device 200, such as in files, or the baseline images may be retrieved from remote storage via a server (not shown).

Application 202 generates output display data for display on a secondary display. Application 202 then queries display module 204 for an active secondary display. Display module 204 provides information associated with the active secondary display to application 202 when an active secondary display is available. Display module 204 also provides application 202 with information regarding the availability of external display simulator 206. Application 202 queries display module 204 for the display modes supported on the active secondary displays and on external display simulator 206.

Instead of querying secondary display driver 209, display module 204 queries external display simulator 206 for supported display modes. External display simulator 206 informs display module 204 of the different display modes that external display simulator 206 is configured to support. External display simulator 206 also informs display module 204 that other display modes may be supported for verification after programming external display simulator 206 via control panel 207. A user may then program external display simulator 206 to support a specific display mode. For example, external display simulator 206 may be programmed to support any conceivable resolution, such as 800×600 or 1024×768, or a particular dots-per-inch (dpi) value.

Display module 204 queries application 202 for the display data to be verified and the corresponding display mode. Application 202 selects an appropriate display mode based on the display data to be verified and forwards the display data to display module 204. The display data is then forwarded to external display simulator 206. External display simulator 206 may select an appropriate output destination for verifying the display data based on programmed settings, stored information (e.g. data stored in file 254 or database 256), the selected display mode, and/or the display data to be verified. For example, the display data may be stored in a format supported by file 254 or database 256 (e.g., a bitmap), or provided to application 258 or a memory device. Alternatively, the display data may be formatted for a display mode supported by secondary display 252. Secondary display 252 can display the display data without special hardware requirements. For example, display data output from a mobile communication device having a small display may be viewed on a display having a larger form factor, such as a desktop monitor, without requiring any additional hardware. External display simulator 206 then forwards the display data to the appropriate output destination 250 where the display data may be stored and verified. In one embodiment, application performance is measured during the verification process.

In one embodiment, external display simulator 206 renders output from application 202 to a window associated with application 258. The window is configured to display the data in accordance with a predetermined display mode. A developer may then access the window via primary display 205 or secondary display 252 to determine whether the display data is properly rendered on a display that supports the predetermined display mode. For example, slides associated with a visual presentation application may be verified for proper rendering on a projector without the use of the projector.

External display simulator 206 may also verify animations and transitions. An animation is a series of visual images. A transition is a visual effect that may be applied to an object (e.g., a fade-in effect). In one embodiment, an animation/transition sequence includes a series of bitmaps output from application 202 and displayed at very small time intervals to provide the illusion of motion. Animation and transition verification was previously performed manually because the capture of timed image sequences was not possible. External display simulator 206 captures all of the animation and transition frames that are sent from display module 204 to secondary display driver 209. The frames may be reconstructed to verify the entire animation/transition sequence. Animation performance metrics may also be generated to identify any problems. For example, an animation may be running slower as a result of a lagging processing speed associated with computing device 200. Individual frame information may also be verified.

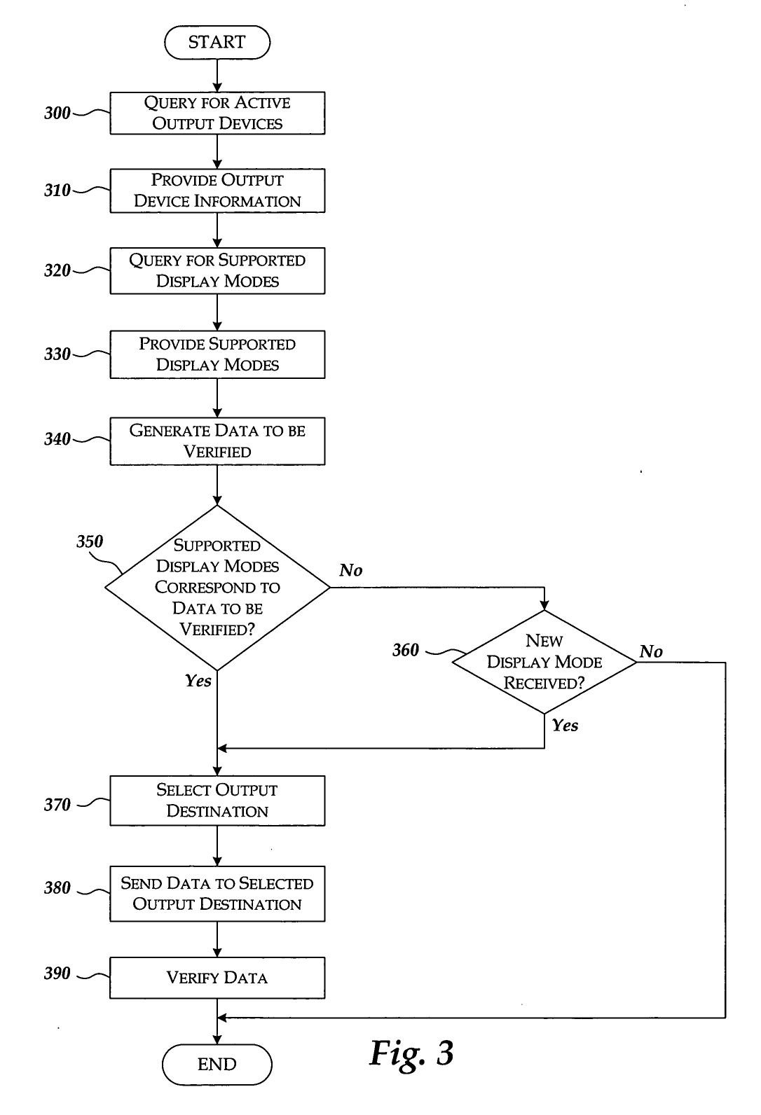

FIG. 3 illustrates a logic flow diagram for a process of simulating an external display. The process begins at operation 300 where an application executing on a computing device queries a display module for an active output device that is coupled to the computing device. Advancing to operation 310, the display module provides to the application information associated with any active output devices. The display module also informs the application that an external display simulator is available. Transitioning to operation 320, the application queries the external display simulator for supported display modes. The external display simulator may be configured to support a variety of different display modes (e.g., 320×240, 640×480). Continuing to operation 330, the display module provides the display modes supported by the external display simulator to the application.

Moving to operation 340, the application generates display data to be verified. The display data may correspond to visual information that is formatted in accordance with the display mode supported by the output device that may be externally coupled to the computing device. For example, the display data may be formatted for display on a monitor having a 1280×1024 resolution.

Proceeding to decision operation 350, a determination is made whether the display modes supported by the external display simulator correspond to the display data generated by the application for verification. If the display data to be verified corresponds to a display mode supported by the external display simulator, processing continues to operation 370. If the display data to be verified does not correspond to a display mode supported by the external display simulator, processing continues to decision operation 360.

Moving to decision operation 360, a determination is made whether a user has responded to a prompt to program a new display mode that supports the display data to be verified. The user may access a control panel on the computing device to configure the external display simulator to support a new display mode. If the user programs the external display simulator to support a new display mode, processing continues to operation 370. If the user does not program the external display simulator to support a new display mode, processing terminates at an end operation because the external display simulator does not support a display mode corresponding to the display data to be verified.

Advancing to operation 370, the output destination where the display data is to be sent is selected. The output destination may be selected based on the display data to be verified, the display mode corresponding to the display data to be verified, or programmed settings on the external display simulator. Transitioning to operation 380, the display data to be verified is sent to the selected output destination for storage. The output destination may be internal to the computing device such as a file, database, application, primary display or memory device. Alternatively, the output destination may be externally coupled to the computing device such as a monitor or a projector. Continuing to operation 390, the display data is verified at the output destination. The display data may be verified by comparing the display data to an expected result. Processing then terminates at the end operation.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computer-implemented method for simulating an external display, comprising:
generating display data to be displayed on an output device, wherein the display data is formatted in accordance with a display mode supported by the output device;
selecting an output destination to send the display data, wherein the output destination supports the display mode of the display data; and
sending the display data to the selected output destination, wherein the display data is verified at the output destination.

2. The computer-implemented method of claim 1, further comprising receiving a new display mode that is supported by the output destination.

3. The computer-implemented method of claim 1, further comprising verifying the display data by comparing the display data to an expected result.

4. The computer-implemented method of claim 1, further comprising verifying the display data when the display data is properly rendered at the output destination.

5. The computer-implemented method of claim 1, wherein selecting an output destination further comprises selecting an output destination based one or more of: the display data, the display mode and programmed settings.

6. The computer-implemented method of claim 1, wherein selecting an output destination further comprises selecting an internal output destination, and wherein the internal output destination comprises one of: a file, a database, an application, a memory device and a primary display.

7. The computer-implemented method of claim 1, wherein selecting an output destination further comprises selecting an external display.

8. The computer-implemented method of claim 1, wherein generating display data further comprises generating an animation/transition sequence such that the animation/transition sequence is verified at the output destination.

9. An external display simulator that is configured to:
receive display data from an application executing on a computing device, wherein the display data is formatted for display on an output device in accordance with a display mode supported by the output device,
select an output destination to send the display data, wherein the output destination supports the display mode of the display data, and
send the display data to the selected output destination, wherein the display data is verified at the output destination.

10. The external display simulator of claim 9, wherein the external display simulator is further configured to be programmable to generate a new display mode that is supported by the output destination.

11. The external display simulator of claim 9, wherein the display data is verified by comparing the data to an expected result.

12. The external display simulator of claim 9, wherein the display data is verified when the display data is properly rendered at the output destination.

13. The external display simulator of claim 9, wherein the output destination is selected based on at least one of: the display data, the display mode and programmed settings.

14. The external display simulator of claim 9, wherein the output destination is selected by selecting an output destination located within the computing device, and wherein the output destination comprises one of: a file, a database, an application, a memory device and a primary display.

15. The external display simulator of claim 9, wherein the output destination is selected by selecting a display that is external to the computing device.

16. The external display simulator of claim 9, wherein the display data is an animation/transition sequence.

17. A computer-readable medium having computer-executable instructions for simulating an external display, the instructions comprising:
generating display data to be displayed on an output device, wherein the display data is formatted in accordance with a display mode supported by the output device;
selecting an output destination to send the display data based on the display data and the display mode, wherein the output destination supports the display mode of the display data, and wherein the output destination is not the output device; and
sending the display data to the selected output destination, wherein the display data is verified at the output destination.

18. The computer-readable medium of claim 17, further comprising receiving a new display mode that is supported by the output destination.

19. The computer-readable medium of claim 17, wherein selecting an output destination further comprises selecting an internal output destination, and wherein the internal output destination comprises one of: a file, a database, an application, a memory device and a primary display.

20. The computer-readable medium of claim 17, wherein selecting an output destination further comprises selecting an external display.
